(19) United States
(12) Patent Application Publication
(10) Pub. No.: US 2005/0084138 A1
(43) Pub. Date: Apr. 21, 2005

(54) System and method for identifying a person

(76) Inventors: D Robert Inkster, Victoria (CA); David M Lokhorst, Victoria (CA); Ernest M Reimer, Outer Cove (NL)

Correspondence Address: OYEN, WIGGS, GREEN & MUTALA;480 - THE STATION, 601 WEST CORDOVA STREET, VANCOUVER, BC, V6B 1G1, CA

(21) Appl. No.: 10/503,438

(22) PCT Filed: Feb. 13, 2002
(86) PCT No.: PCT/CA03/00195

(30) Foreign Application Priority Data
Feb. 13, 2002 (CA) 2371665

(51) Int. Cl. G06K 9/00

(52) U.S. Cl. 382/115

(57) ABSTRACT

A method for verifying the identity of a person comprises providing a plurality of pressure transducers and deriving a key from pressures measured by the pressure transducers when a person presses a hand (or other body part) against the pressure transducers. The key can be compared to a previously stored reference key. Apparatus for verifying the identity of a person may have an array of pressure transducers coupled to a controller. The controller produces the key and compares it to a reference key.

### TECHNICAL FIELD

The invention relates to methods and apparatus for verifying the identities of people. The invention may be applied in fields such as securing access to premises, securing access to computer systems, verifying that a particular person was at a particular place at a particular time, or the like.

### BACKGROUND

There are a wide variety of situations in which it is necessary to provide a mechanism fo reliably identifying a person. Secret passwords can be used for this purpose, however such passwords can be compromised. Complicated passwords are hard to remember. Physical devices such as smart cards, keys and the like can be lost and can also be used if they fall into the wrong hands.

The deficiencies of the prior art have resulted in increased attention being paid to biometric identification techniques. Systems which identify people by way of their fingerprints, iris patters, photographs, tissue spectra, voice characteristics and the like have been demonstrated. Such systems suffer from various disadvantages. In many cases the systems require expensive apparatus to implement. Such systems can also require significant computation resources to implement.

Despite the very extensive research and great resources that have been expended in developing biometric identification systems there remains a need for such systems that can be implemented in a cost effective manner.

### DESCRIPTION OF THE DRAWINGS

In drawings which illustrate non-limiting embodiments of the invention:

FIG. 1 is a representation of a touch-sensitive surface according to one example embodiment of the invention;

FIG. 2 is an elevational view of a touch-sensitive surface according to an alternative embodiment of the invention wherein the surface is curved;

FIGS. 3a and 3b are respectively sets of pressure profiles for two different persons;

FIG. 4 is a block diagram of apparatus according to an example embodiment of the invention for verifying the identity of a person;

FIG. 5 is a block diagram of apparatus according to another example embodiment of the invention for verifying the identity of a person;

FIG. 6 is a flow chart illustrating a method of the invention;

FIG. 7 is a flow chart illustrating one way to pre process data in the invention;

FIG. 8 is a plot illustrating how a pressure profile at a touch-sensitive surface can vary in time as a user applies pressure to a touch-sensitive surface;

FIG. 9 is a plot illustrating the way at which pressure can vary with time at a number of locations as a user applies pressure to a touch-sensitive surface;

FIG. 10 is a perspective view of a handle incorporating a touch-sensitive surface according to the invention;

FIG. 11 is a perspective view of a steering wheel incorporating a touch-sensitive surface according to the invention;

FIG. 12 is a perspective view of a hand gun incorporating a touch-sensitive surface according to the invention;

FIG. 13 is a perspective view of a keyboard incorporating a touch-sensitive surface according to the invention; and,

FIG. 14 is a perspective view of a computer mouse incorporating a touch-sensitive surface according to the invention.

### DESCRIPTION

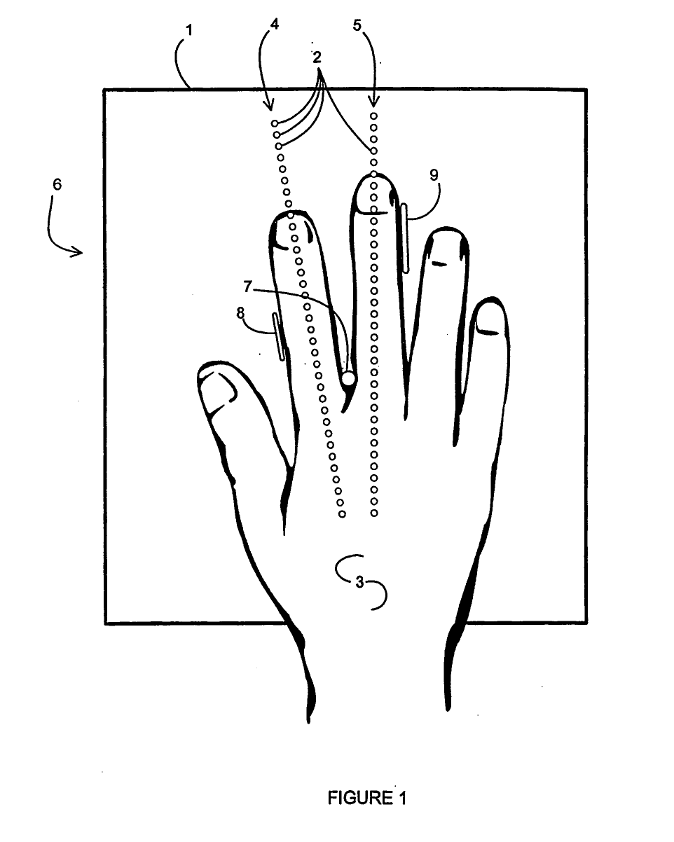

Systems according to this invention use touch-sensitive sensors to make measurements that are characteristic of individual people. One aspect of this invention relates to a touch-sensitive sensor suitable for making such measurements. FIG. 1 illustrates a sensor 6 according to one embodiment of the invention. Touch sensor 6 has a substantially flat surface 1. Pressure transducers sense pressure applied at a plurality of points 2 on surface 1. The user (i.e. the individual who wishes to have his identity verified) places his or her hand 3 onto surface 1, and presses against surface 1 with hand 3. In this embodiment, the pressure transducers are arranged to sense pressures at points arranged along two substantially linear arrays (4 & 5) which underlie the index and middle fingers of the user.

Several parameters related to the geometric layout of the pressure transducers are important. It is preferred (but not essential) that the linear arrays of pressure transducers are of sufficient length to extend past the fingertip of the longest finger of all individuals in the set of people to be identified. The inventors have discovered that the spacing of the pressure transducers 2 must be small enough to measure the changes in pressure that occur over the length of the finger; in some embodiments the pressure transducers are spaced apart with a spacing between adjacent pressure transducers in the range of 1 mm to 5 mm. The pressure transducers are preferably regularly spaced.

To improve the performance of the system, additional features may be added to the touch sensor in order to spatially “register” the user's fingers in a repeatable manner. For example, a guide 7 may be provided to fix a location of a junction between the user's first and second fingers. Guide 7 may, for example, comprise a fixed cylindrical member projecting upwardly from surface 1. Guide 7 may extend perpendicularly to surface 1 for a distance of 15 mm or so. In the illustrated embodiment of the invention, two other guides (8 & 9) are provided to locate the user's first and second fingers. Guides 8 and 9 are fixed relative to surface 1 and extend approximately 15 mm perpendicularly from the surface.

The user places his hand on surface 1 and locates it such that the spot between the first and second knuckles is pressed firmly against guide 7, the index finger rests against guide 8, and the middle finger is resting against guide 9.

It is preferred that surface 1 be smooth and that transducers which sense pressure applied at points 2 be embedded behind surface 1. The transducers which sense pressures applied to points 2 may be implemented using any suitable pressure-sensing technology. Any transducer capable of converting applied pressure or applied force into a detectable signal such as a voltage signal, a current signal, a light signal or the like can be used. For the purpose of this disclosure, the term “pressure transducer” applies to any suitable sensor technology. For example, pressure transducers suitable for use in this invention include KINOTEX™ pressure transducers (which is commercially available from Tactex Controls Inc. of Victoria B.C. Canada) and force-sensitive resistors (which are commercially available from a number of sources). The choice of pressure transducer technology does not limit this invention.

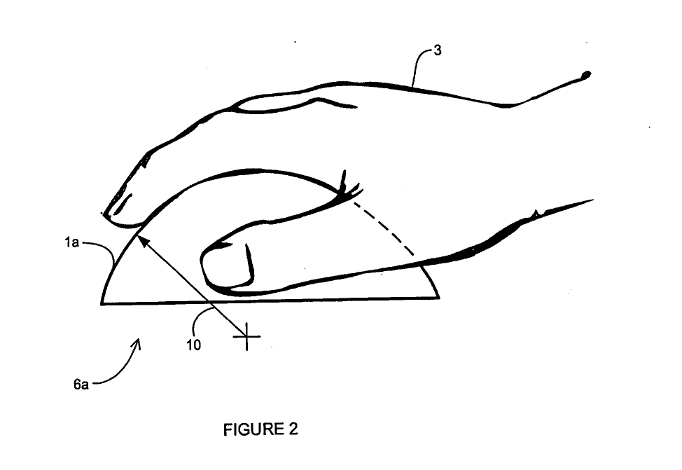

To improve the comfort of the device, it is preferred to provide some curvature to the surface, as shown in FIG. 2. The touch sensor 6a illustrated in FIG. 2 has a curved surface 1a. Surface 1a has a radius of curvature 10 which is preferably in the range of 50 mm and 200 mm. Surface 1a may have different radii of curvature in different planes. The user places hand 3 so that the fingers comfortably wrap around touch sensor 6a as shown.

In the embodiment of FIG. 2, guides similar to guides (7,8,9) may be provided. The guides may have different shapes, sizes, and locations. Some embodiments of the invention may not require guides. In some embodiments of the invention surface 1 may be imprinted with indicia which indicate where fingers of a user's hand 3 should be placed on surface 1 (or 1a).

The geometrical arrangement of the points 2 at which the pressure transducers monitor pressure may be varied extensively without departing from the invention. For example, a regularly spaced rectangular array (i.e. rows and columns) of pressure transducers can be embedded in surface 1 or (1a). In another example, pressure transducers can be provided to measure pressures at points arranged in five linear arrays, one of the linear arrays underlying each finger and thumb of a user.

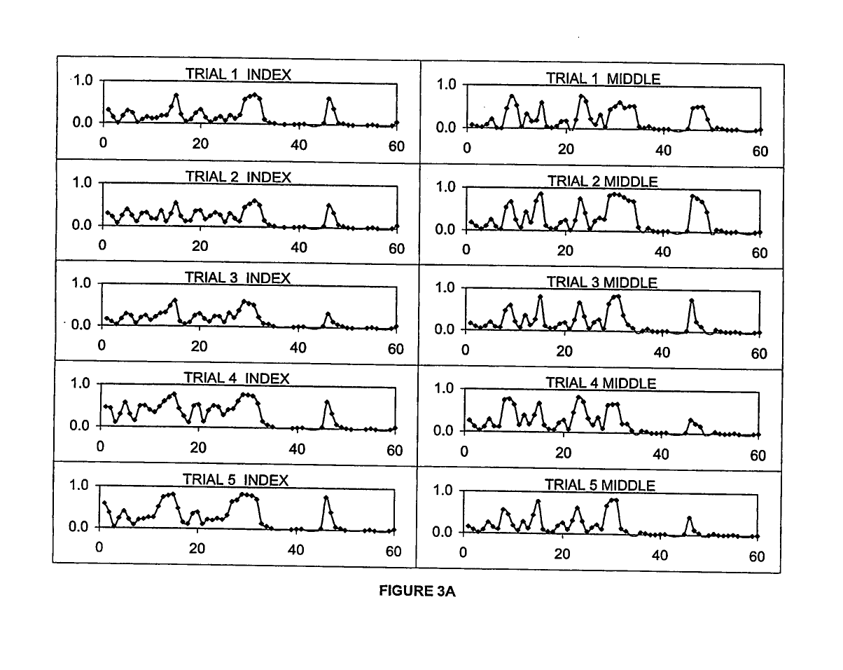

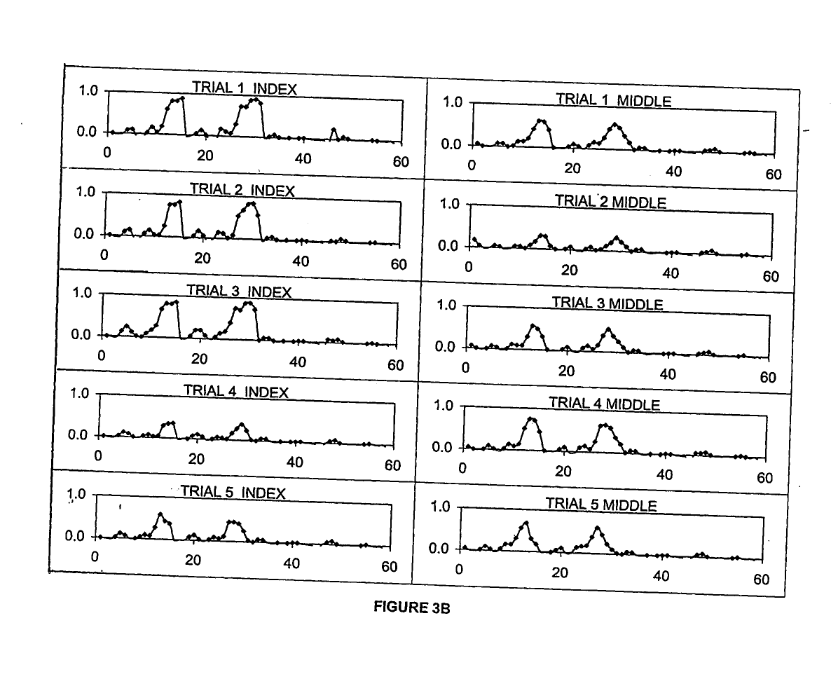

When a user presses hand 3 against a touch sensor (6 or 6a) a set of pressure readings is created. The set of pressure readings may be called a “pressure profile.” The pressure profile is essentially a data vector (i.e. a 1×N array, where N is the number of pressure transducers). The graphs on the left hand side of FIG. 3a illustrate the pressure profile recorded in each of a number of trials. Each pressure profile is made up from pressures measured by a row of transducers under a first individual's index finger. The graphs on the left hand side of FIG. 3b illustrate similar pressure profiles taken from a second individual.

The pressure profiles shown in FIGS. 3a and 3b are typical of the profiles obtained by linear arrangements of pressure transducers which underlie a user's finger. Although it is possible to characterize an individual based on a single linear array (for example, an array of transducers which measure pressures at points located under the user's index finger) it is preferred that pressure profiles under two (or more) fingers are acquired from the individual. This can be done by using a touch sensor (1 or 1a) as described previously, or by means of a single array of pressure transducers to which the user applies two fingers (e.g. his index and middle finger) sequentially. By whatever method the pressure profile of each finger is obtained, a complete pressure profile for an individual may be made by combining (for example by concatenation) the pressure profiles produced by two or more of the individual's fingers.

For example, a touch sensor 1 which has 30 pressure transducers in array 4 and 50 pressure transducers in array 5, can be used to provide a 30-element long index finger pressure profile and a 50-element long middle finger profile. These two finger profiles may be combined to yield an aggregate pressure profile that is 80 elements long. The inventors have found that each person produces a pressure profile that is characteristic of that person. By this, it is understood that the pressure profile has two characteristics:
The pressure profile is repeatable. That is, pressure profiles from a given individual are similar (the same within known tolerances) despite being measured at different times.
The pressure profile is largely unique to the individual. That is, the pressure profiles of the vast majority of other people differ from that of any given individual by amounts greater than the normal variation in the individual's own readings.

The pressure profiles may bear some relationship to the anatomical structure of the user's hand. However, it is not necessary to this invention to understand or to know why particular individuals produce the pressure profiles that they do.

On the basis of the repeatability and uniqueness of the pressure profile, it is possible to construct a system to verify the identity of an individual. Several such systems are described here. The systems may be employed to provide access control, to validate time cards, to enable/disable alarm systems, or for a variety of other applications.

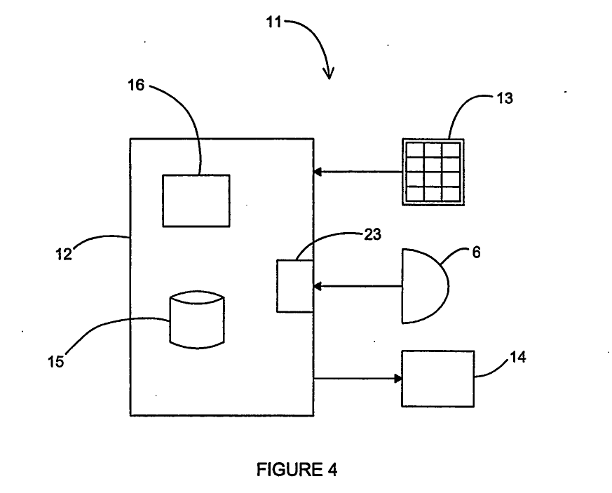

A stand-alone identity verification system 11 is schematically represented in FIG. 4. System 11 comprises a digital computer 12 and several peripherals: a touch sensor 6, which maybe as described above, a keypad input device 13, and an output device 14. Computer 12 operates database software and hardware (collectively 15) and verification software 16. Computer 12 is equipped with a data acquisition interface 23 that reads in data from the pressure transducers of touch sensor 6. Computer 12 may comprise a general purpose computer, an embedded processor, a microcontroller or the like. In some applications, especially simpler applications where it is only necessary to verify the identity of one person, computer 12 maybe replaced with “hard wired” logic circuits.

Output device 14 is controlled by computer 12 and may be one of several types, depending upon the application. For example, output device 14 may be of a type that operates a door lock, if the identity verification system 11 is to be used to control access to a building or room. For another example, output device 14 may be of a type that punches time-cards for employees. For another example, output device 14 may comprise a software process running on the computer 12 that permits the user access to network services, printers, databases, the internet, etc.

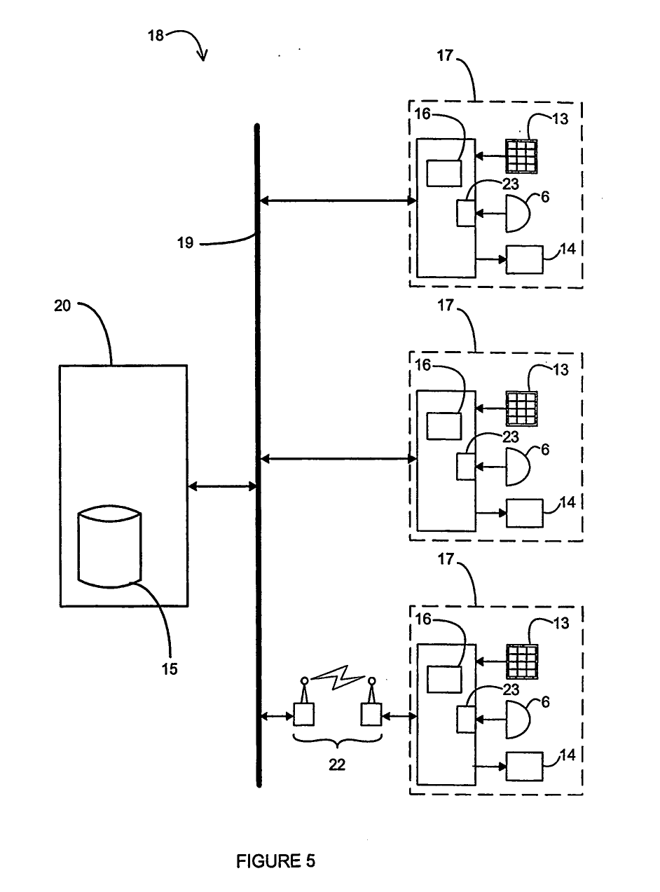

A more elaborate identity verification system 18 is schematically represented in FIG. 5. It provides a system with multiple points of access. System 18 has a central database 15 which resides on a suitable server 20 which is in data communication with a plurality of stations 17 over a network 19. Network 19 may comprise one or more wireless links 22. Each station 17 has a touch sensor 6, an input device 13 and an output device 14.

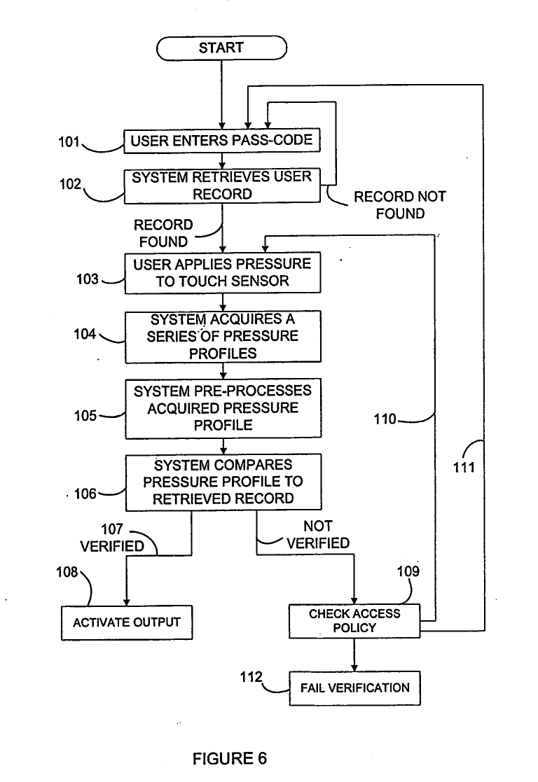

A flowchart describing how these systems (11 & 18) can be used is shown in FIG. 6. A user wishing to have his identity verified first enters an ostensibly secret pass-code into the keypad (step 101). Software 16 then accesses database 15 either locally or over the network 19, (step 102). The user applies pressure to the touch sensor 6, (step 103), and the acquisition interface 23 acquires the user's pressure profile, (step 104). Software 16 then pre-processes the pressure profile, (step 105), to prepare it for comparison with stored reference data for that user. Pre-processing step 105 may involve a number of sub-processes such as normalizing, shifting, concatenating or otherwise arranging the data. Pre-processing step 105 may also involve deriving metrics from the data or compressing the data. Details of the preferred embodiment of this step are discussed subsequently. Software 16 then compares the pressure profile (or derivatives of it) to a reference key for that user (step 106). A reference key is stored in database 15 for each authorized user.

If step 106 determines that the acquired pressure profile does match the stored reference key, then the user is authorized, (step 107), and the output device is activated, (step 108). If the comparison is not successful, then the software 16 checks an access policy, (step 109). That access policy 109 may include limits on the number of attempted accesses in a set period of time. Access policy 109 may also retrieve additional data from a database (15 or other) regarding general access policies or specific information related to the user. The check against access policy may result in forcing the user to retry acquiring the pressure profile, (path 110), it may force the user to re-enter a pass-code, (path 111), or it may reject authorization, (step 112), by which we mean that the identity of the user has not been verified.

The step 101 of entering the user's pass-code is not necessary in all implementations. In installations where there is intended to be only a single user allowed (for example, access to a safe), then the database 15 needs to only store one set of data (e.g. one reference profile), and the user's pressure profile can be compared against that data only.

It is possible to use a touch sensor 6 for other purposes in addition to its purpose of acquiring the user's pressure profile. In system 11, it maybe convenient to combine the keypad and touch sensor into a single device. Since the touch sensor 6 is inherently pressure sensitive, a graphic indicating alphanumeric “buttons” can be applied to or incorporated in surface 1. Software.16 maybe configured to interpret the pressure data as a pass-code or a pressure profile depending on which step of the process it is executing. Touch sensor 6 may operate like a keypad during step 101 and as described above during steps 103 & 104.

Step 105 pre-processes the pressure profile for subsequent comparison to stored data for a particular individual. The result of step 105 may be considered to be a “key” which is characteristic of the individual. Step 106 makes the comparison between the key and a previously stored reference key.

It is also necessary to establish a database of reference keys for users of system 11. The reference key for each user is or, more commonly, is derived from a pressure profile for that user. The users' reference pressure profiles may be obtained in a manner similar to that of steps 105 & 106. For example, each new user may be required to provide several (for example, five) “trial” pressure profiles. An average of those pressure profiles is stored on database 15 as that individual's “reference profile.” A measure of the normal (anticipated) deviation from the profile can be computed from the trial pressure profiles. That deviation may also be stored on the database 15. The deviation represents the tolerance that will be applied to the pressure profile during comparison. At such time as the user requires his identity to be verified by the system, the deviation from the currently acquired pressure profile relative to his stored profile is measured, and if it falls within the recorded tolerance, the pressure profile may be deemed to match that of the user.

It is a further benefit if the amount of data related to each user can be minimized. This will make the size of database 15 more manageable and decrease the time taken to perform comparisons. There are well known methods for compressing data that will work on these data.

The following method may be used for comparing the pressure profiles. It is based on the known method of principle component analysis. The procedure requires the establishment of database 15 as follows:
1. Collect pressure profiles from a number of trials from each of a large number of users.
2. Form a matrix of the number of pressure profiles. For example, if the hand sensor has 80 pressure transducers, and data is collected from 100 individuals, each of whom conducted 5 trials, the matrix will be 80×500.
3. Form a covariance matrix, being the product of the data matrix from the previous step with its transpose. The covariance matrix will be a symmetric matrix of the dimension equal to the number of pressure transducers (for example, 80×80 for the example given above).
4. Determine the eigenvalues and eigenvectors of the covariance matrix. Consider largest eigenvalues and their corresponding eigenvectors. The eigenvectors are an orthogonal basis set. The majority of the information contained in the pressure profiles is represented by a linear combination of relatively few eigenvectors. Those few eigenvectors are called the principle directions. The inventors have found that over 90% of the information in the pressure profiles is contained in six principle directions. The principle directions are individual vectors (80 elements long, for the example above) and they are constant and they need only ever be computed once. We conclude that we can characterize the pressure profile of any given user by 6 principle components—these are essentially “distances” in each of the primary principle directions. That is, any pressure profile can be reduced to 6 numbers by simply taking the dot product of the pressure profile with each principle direction. (Note that the original pressure profile can be reproduced with high accuracy from the 6 principle components and the known principle directions.) It is convenient to think of these 6 principle components as specifying a point in a 6-dimensional space. Then we can consider some familiar geometric concepts to analyse the data.
5. For each user whose identity will be verified, collect several (at least 5) sets of pressure profiles. Determine the principle components of those trials. All trials related to a given individual should be clustered in 6-space. For each individual compute the centre of the cluster. The size of the cluster can be computed with the usual formula for standard deviation. In summary, for each user there is a dimensional surface that encloses the trials for that individual. The surfaces for different users have different locations and shapes depending on the spread of the principle components derived from each individual's trials.
6. Each individual user's stored profile or “reference key” may comprise 12 numbers: the 6 principle components of the centroid of that individual's cluster, and the 6-dimensional size of the cluster. These 12 data constitute a record for that individual stored on the database (in addition to any other data that may be required for other purposes, such as the user's pass-code, name, access policies, etc.)

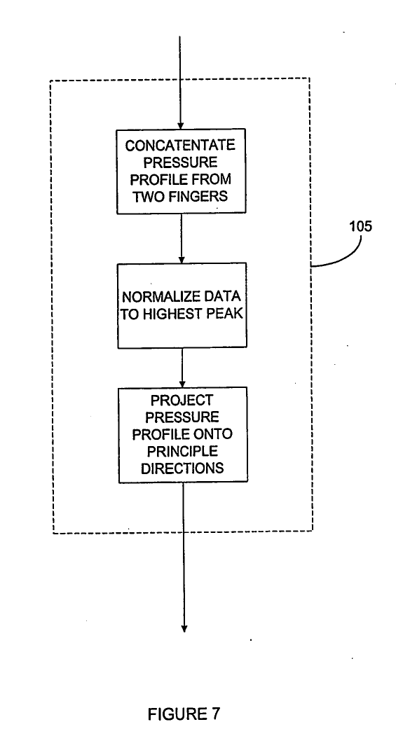

FIG. 7 shows one way to implement step 105 which involves projecting an acquired pressure profile onto the principle directions, resulting in 6 principle components each time the user's identity needs to be validated. Those 6 principle components are checked by software 16 in step 106 to determine if they fall within the 6-dimensional cluster for that user.

It is important to note that the principle components of the data are not directly related to any anatomical characteristic (such as the length of the user's index finger). Fundamentally, this invention does not require an understanding of the relationship between the pressure profile and the anatomical structure of the user's hand (i.e. hand geometry).

The foregoing discussion has concentrated on the static pressure profile produced when a user presses his or her hand against a touch sensor 6 (or 6a). That is, we discussed the nature of a “snapshot” of the pressure profile taken at one instant in time. Obviously, as the user applies and relieves pressure to the touch sensor 6, the readings from the pressure transducers will vary in time. In general, the readings will rise to some value as the user applies pressure and then fall again as the user removes his hand. It is also found that some transducer readings rise and fall several times, even as the user is increasing the total force applied to the pad. This pressure variation is largely involuntary—that is, not under the conscious control of the user.

The inventors have discovered that the pattern of changes in pressure that occur with time are also characteristic of the individual. In other words, the time history of the pressure profile has the following characteristics:
1. The time response of the pressure profile is repeatable. That is, a given user will have similar time response, even though it may be measured at different times.
2. The time response is largely unique to the individual. That is, the pressure profiles of the vast majority of other people differ from the any given individual by amounts greater than the normal variation in the individual's own response.

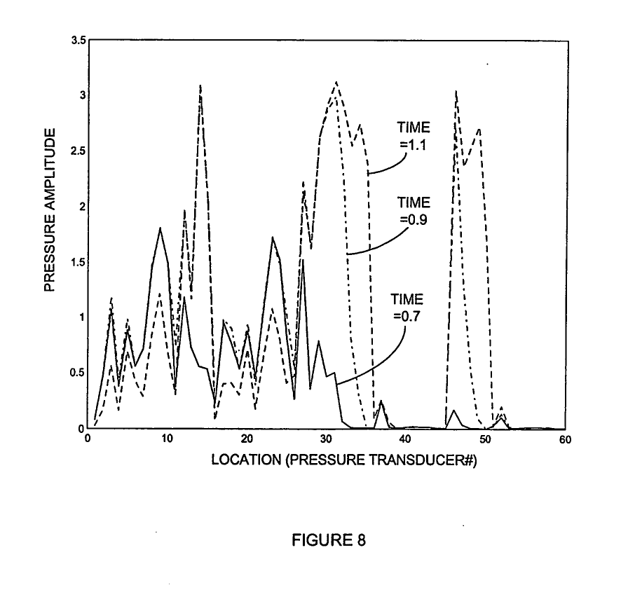

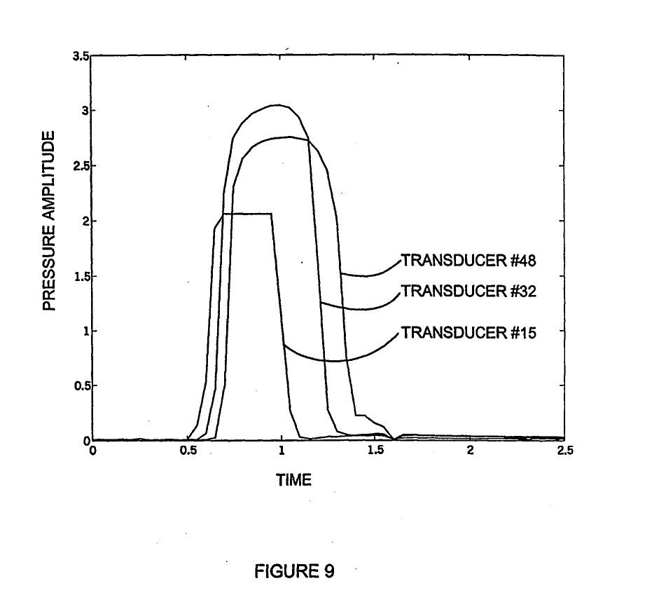

FIG. 8 illustrates the involuntary pressure signature of a person over a period of time. This figure shows a typical pressure profile of an index finger, measured with 60 pressure transducers. Three lines are indicated, showing the development of the pressure as the user grasps the hand sensor. The three lines indicate three successive times. FIG. 9 illustrates the variation of pressure with time at three different locations as the user grasps (and subsequently releases) the hand sensor. The data plotted here were acquired during the same grasp as is plotted in FIG. 8. Another aspect of some embodiments of this invention is that the user can add a conscious pressure “signature.” This can be kept secret.

This invention also provides apparatus and methods to verify the identity of a person who is grasping an object. As illustrated in FIG. 2, a curved surface is more comfortable to the user. The surface can be curved even more, to the point where it can be grasped by the user.

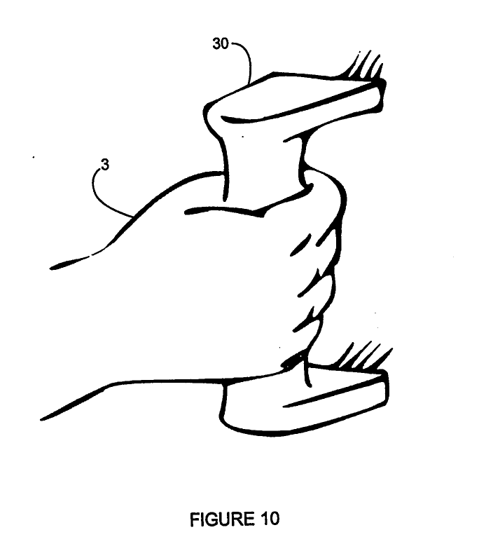

FIG. 10 illustrates a user's hand 3 grasping a touch sensitive handle 30. Touch sensitive handle 30 has a plurality of pressure transducers embedded in it. During the conscious (i.e. intentional) act of grasping the handle, the user implements a sequence of unconscious (i.e. reflexive) actions of his fingers, wrist, and arm. The sequence of actions leads to a sequence of pressures applied by the user's fingers and palm to the surface of handle 30. The pressure transducers are arranged in a manner such that a sufficient number of them underlie the user's fingertips and (optionally) his palm. Data is preferably acquired from the sensors at a frequency sufficient to capture the highest expected frequency components of the grasping pressure profile.

The data acquired differ from the static pressure profiles previously in that they include additional time information. However, the data may be processed in a manner similar to that described above. The stored reference key may contain information about how the pressure profile, or individual parts of the pressure profile vary with time for a particular user.

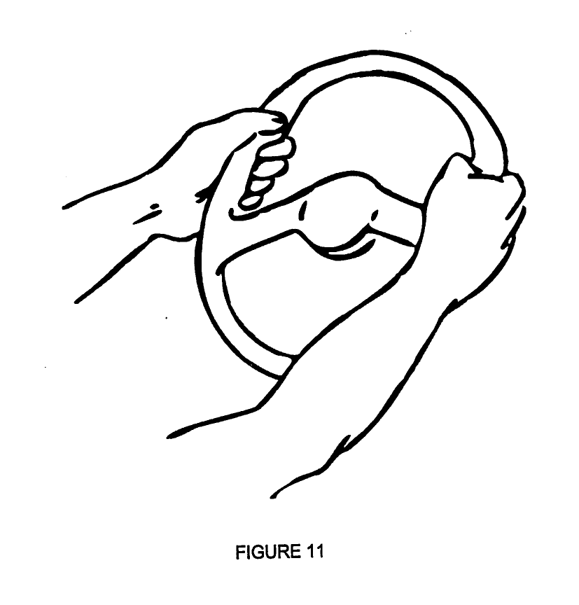

FIG. 11 illustrates a user grasping the steering wheel of a motor vehicle. Pressure transducers are embedded in the steering wheel, and a system is used to verify the identity of the user. In this case, the output device 14 is activated by the computer to enable the motor vehicle to be started or put into drive.

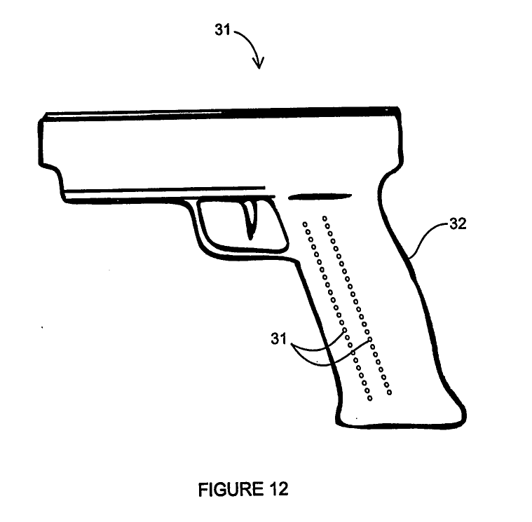

FIG. 12 illustrates a firearm 31. The grip 32 of firearm 31 houses an array of pressure transducers 33.

From the foregoing discussion, it is clear that the present invention is widely applicable to situations where a user needs to assert his or her identity. It common to protect access to computer and information resources (i.e. computer networks, databases, stored information, printers, etc.) by means of a password. An increased level of security is achieved by combining password protection with the biometric security provided by this invention. To this end, it is an aspect of this invention that a touch sensor capable of obtaining a user's pressure profile can be integrated with common computer input devices.

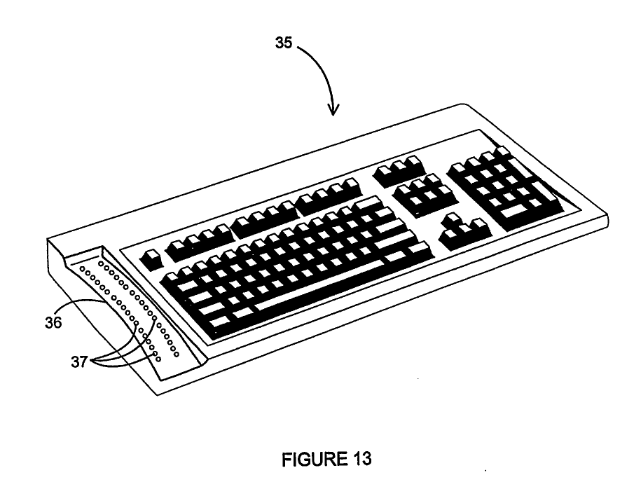

For example, FIG. 13 illustrates a computer keyboard 35. A surface 36 is located conveniently on keyboard 35. Pressure transducers 37 are embedded in the surface 36.

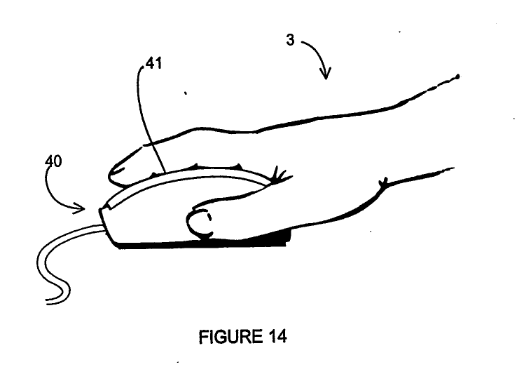

As another example, FIG. 14 illustrates a computer mouse 40. A surface 41 which is equipped with pressure transducers, as described above, is integrated into the surface of the mouse 40.

As will be apparent to those skilled in the art in the light of the foregoing disclosure, many alterations and modifications are possible in the practice of this invention without departing from the spirit or scope thereof.

1. A device for measuring the pressure profile applied by a person's hand, comprising a plurality of sensors, each of which measures the pressure at known position, such that the pressure profile is characteristic to an individual.

2. A device as in claim 1 that is used for measuring the pressure distribution applied by a person's finger, thumb, multiple fingers, palm, or any combination of these.

3. A device as in claim 1 comprising pressure sensors made of Kinotex™.

4. A device as in claim 1 comprising pressure sensors made of force sensitive resistive material.

5. A device as in claim 1 comprising means for measuring and recording a time-history of the pressure signals.

6. A device as in claim 1 so arranged that a person may grasp it, and in which the pressure sensors are arranged so that the biometric pressure distribution of the grasp may be detected.

7. A device as in claim 6 that includes embedded processes that identify a time-varying grasp signature.

8. A device as in claim 1 that is mounted on a computer mouse.

9. A device as in claim 1 that is mounted on a computer keyboard.

10. A device as in claim 1 that is mounted on a handle on or nearby a door.

11. A device as in claim 1 that is affixed to the grip of a firearm.

12. A method for verifying the identity of a person, the method comprising:
recording signals from an array comprising a plurality of pressure sensors while the person presses a part of the person's body against the array;
generating a key characteristic of the person from the recorded signals; and,
comparing the key to a previously stored reference key.

13. A method according to claim 12 wherein the part of the person's body is a hand.

14. A method according to claim 12 wherein generating a key comprises decomposing a pressure profile comprising values of the recorded signals into components corresponding to a plurality of eigenvectors.

15. A method according to claim 14 wherein the eigenvectors are eigenvectors of a covariance matrix derived from a matrix of pressure profiles for a large number of people.

16. Apparatus for use in verifying the identification of a person, the apparatus comprising:
a surface;
a plurality of pressure transducers located to generate output signals in response to pressure being applied to the surface;
a controller connected to generate a key characteristic of a person from the output signals of the pressure transducers and to compare the key to a previously stored reference key.

17. The apparatus of claim 16 comprising an input device connected to the controller, the controller adapted to receive by way of the input device information identifying a person and to compare the key to one of a plurality of previously stored reference keys corresponding to the person.

18. (canceled)

19. (canceled)
